(19) United States
(12) Patent Application Publication
(10) Pub. No.: US 2023/0361942 A1
(43) Pub. Date: Nov. 9, 2023

(54) UPLINK DATA SENDING METHOD AND CONFIGURATION METHOD, TERMINAL, AND NETWORK SIDE DEVICE

(71) Applicant: VIVO MOBILE COMMUNICATION CO., LTD., Dongguan (CN)

(72) Inventors: Wei BAO, Dongguan (CN); Na LI, Dongguan (CN)

(73) Assignee: VIVO MOBILE COMMUNICATION CO., LTD., Dongguan (CN)

(21) Appl. No.: 18/221,426

(22) Filed: Jul. 13, 2023

Related U.S. Application Data
(63) Continuation of application No. PCT/CN2022/070511, filed on Jan. 6, 2022.

(30) Foreign Application Priority Data
Jan. 13, 2021 (CN) 202110043139.4

(51) Int. Cl. H04L 1/1867; H04L 5/00; H04W 72/02; H04W 72/563

(52) U.S. Cl. CPC H04L 1/1887; H04L 5/0005; H04W 72/02; H04W 72/563

(57) ABSTRACT

An uplink data sending method and configuration method, a terminal, and a network side device are provided. The uplink data sending method includes: when a plurality of transport blocks are transmittable on a same time-frequency resource of a same configured grant, selecting a first transport block from the plurality of transport blocks to transmit on the time-frequency resource, where the first transport block is a transport block to be retransmitted or a transport block with a highest logical channel priority among the plurality of transport blocks.

### CROSS-REFERENCE TO RELATED APPLICATIONS

This application is a continuation of International Application No. PCT/CN2022/070511, filed Jan. 6, 2022, which claims priority to Chinese Patent Application No. 202110043139.4, filed Jan. 13, 2021. The entire contents of each of the above-referenced applications are expressly incorporated herein by reference.

### TECHNICAL FIELD

This application relates to the field of wireless communication technologies, and in particular, to an uplink data sending method and configuration method, a terminal, and a network side device.

### BACKGROUND

A Network (NW) can configure a plurality of sets of Configured Grant (CG) for User Equipment (UE), also known as a terminal, and each set of CG configuration indicates time-frequency location information of a group of periodically allocated resources. A CG time-frequency resource can be used for Hybrid Automatic Repeat reQuest (HARD) initial transmission or retransmission of data.

For one time-frequency resource of one CG, if there are a plurality of Transport Block (TB) that can be transmitted by using the resource, the UE needs to select a transport block carried on the resource. How to choose a transport block carried on a CG time-frequency resource from the plurality of transport blocks is still inconclusive.

### SUMMARY

Embodiments of this application aim to provide an uplink data sending method and configuration method, a terminal, and a network side device.

According to a first aspect, an uplink data sending method is provided, where the method is performed by a terminal and includes:
if a plurality of transport blocks can be transmitted on a same time-frequency resource of a same configured grant, selecting a first transport block from the plurality of transport blocks to transmit on the time-frequency resource, where the first transport block is a transport block to be retransmitted or a transport block with a highest logical channel priority among the plurality of transport blocks.

According to a second aspect, an uplink data sending configuration method is provided, where the method is performed by a network side device and includes:
sending configuration information to a terminal, where the configuration information is used to instruct the terminal to select, if a plurality of transport blocks can be transmitted on a same time-frequency resource of a same configured grant, the transport block to be retransmitted or the transport block with the highest logical channel priority from the plurality of transport blocks as the first transport block for transmission.

According to a third aspect, an uplink data sending apparatus is provided, including:
a selection module, configured to: if a plurality of transport blocks can be transmitted on a same time-frequency resource of a same configured grant, select a first transport block from the plurality of transport blocks to transmit on the time-frequency resource, where the first transport block is a transport block to be retransmitted or a transport block with a highest logical channel priority among the plurality of transport blocks.

According to a fourth aspect, an uplink data sending configuration apparatus is provided, including:
a sending module, configured to send configuration information to a terminal, where the configuration information is used to instruct the terminal to select, if a plurality of transport blocks can be transmitted on a same time-frequency resource of a same configured grant, the transport block to be retransmitted or the transport block with the highest logical channel priority from the plurality of transport blocks as the first transport block for transmission.

According to a fifth aspect, a terminal is provided, where the terminal includes a processor, a memory, and a program or an instruction stored in the memory and executable on the processor, and when the program or instruction is executed by the processor, steps of the method according to the first aspect are implemented.

According to a sixth aspect, a network side device is provided, where the network side device includes a processor, a memory, and a program or an instruction stored in the memory and executable on the processor, and when the program or the instruction is executed by the processor, steps of the method according to the second aspect are implemented.

According to a seventh aspect, a readable storage medium is provided, where the readable storage medium stores a program or an instruction, and when the program or the instruction is executed by a processor, steps of the method according to the first aspect or the second aspect are implemented.

According to an eighth aspect, a chip is provided. The chip includes a processor and a communications interface, the communications interface is coupled to the processor, and the processor is configured to run a program or an instruction of a network side device, to implement the method according to the first aspect or the method according to the second aspect.

According to a ninth aspect, a computer program product is provided. The computer program product is stored in a non-volatile storage medium, and the computer program product is executed by at least one processor to implement the method according to the first aspect or the method according to the second aspect.

In this embodiment of this application, it is specified that when a plurality of transport blocks of the terminal can be transmitted on a same time-frequency resource of a same configured grant, how the terminal selects a transport block carried on the time-frequency resource of the configured grant, so as to meet priority requirements and/or delay requirements of a service.

### BRIEF DESCRIPTION OF DRAWINGS

FIG. 1 is a block diagram of a wireless communications system to which an embodiment of this application is applicable;

FIG. 2 is a schematic diagram of a configured grant resource;

FIG. 3 is a schematic diagram of performing uplink data transmission by using a configured grant resource;

FIG. 4 is a flowchart of an uplink data sending method according to an embodiment of this application;

FIG. 5 is a flowchart of an uplink data sending configuration method according to an embodiment of this application;

FIG. 6 is a schematic diagram of a structure of an uplink data sending apparatus according to an embodiment of this application;

FIG. 7 is a schematic diagram of a structure of an uplink data sending configuration apparatus according to an embodiment of this application;

FIG. 8 is a schematic diagram of a structure of a communications device according to an embodiment of this application;

FIG. 9 is a schematic diagram of a hardware structure of a terminal according to an embodiment of this application; and

FIG. 10 is a schematic diagram of a hardware structure of a network side device according to an embodiment of this application.

### DETAILED DESCRIPTION

The following describes the technical solutions in the embodiments of this application with reference to the accompanying drawings in the embodiments of this application. Apparently, the described embodiments are some rather than all of the embodiments of this application. Based on the embodiments of this application, all other embodiments obtained by a person of ordinary skill in the art without creative efforts shall fall within the protection scope of this application.

The terms “first”, “second”, and the like in the description and the claims of this application are used to distinguish between similar objects instead of describing a specific order or sequence. It should be understood that, data termed in such a way is interchangeable in proper circumstances, so that the embodiments of this application can be implemented in an order other than the order illustrated or described herein. Objects classified by “first” and “second” are usually of a same type, and the number of objects is not limited. For example, there may be one or more first objects. In addition, in the description and the claims, “and/or” represents at least one of connected objects, and a character “/” generally represents an “or” relationship between associated objects.

It should be noted that, the technologies described in the embodiments of this application are not limited to a Long Term Evolution (LTE)/LTE-Advanced (LTE-A) system, and can also be used in other wireless communications systems such as Code Division Multiple Access (CDMA), Time Division Multiple Access (TDMA), Frequency Division Multiple Access (FDMA), Orthogonal Frequency Division Multiple Access (OFDMA), Single-carrier Frequency-Division Multiple Access (SC-FDMA), and another system. The terms “system” and “network” in the embodiments of this application may be used interchangeably. The technologies described can be applied to both the systems and the radio technologies mentioned above as well as to other systems and radio technologies. However, a New Radio (NR) system is described below as an example, and the term NR is used in most of the descriptions, although these technologies can also be used in an application other than an application of the NR system, for example, a 6th generation (6G) communications system.

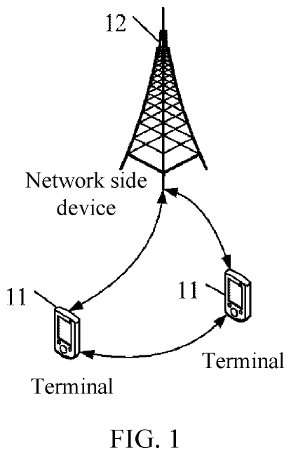

FIG. 1 is a block diagram of a wireless communications system to which an embodiment of this application can be applied. The wireless communications system includes a terminal 11 and a network side device 12. The terminal 11 may also be referred to as a terminal device or UE. The terminal 11 may be a terminal side device such as a mobile phone, a tablet personal computer, a laptop computer or a notebook computer, a personal digital assistant (PDA), a palmtop computer, a netbook, an ultra-mobile personal computer (UMPC), a mobile Internet device (MID), a wearable device, vehicle user equipment (VUE), or pedestrian user equipment (PUE). The wearable device includes a bracelet, a headset, and glasses. It should be noted that a specific type of the terminal 11 is not limited in this embodiment of this application. The network side device 12 may be a base station or a core network. The base station may be referred to as a NodeB, an evolved NodeB (eNB), an access point, a base transceiver station (BTS), a radio base station, a radio transceiver, a basic service set (BSS), an extended service set (ESS), a home NodeB, a home evolved NodeB, a Wireless Local Area Network (WLAN) access point, a Wireless Fidelity (WiFi) node, a Transmitting Receiving Point (TRP), or another appropriate term in the art. As long as the same technical effect is achieved, the base station is not limited to a specific technical term. It should be noted that the base station in the NR system is taken only as an example in the embodiments of this application, but a specific type of the base station is not limited.

With reference to the accompanying drawings, the following describes in detail an uplink data sending method and configuration method, a terminal, and a network side device in the embodiments of this application based on specific embodiments and application scenarios thereof.

First, the communication terms involved in this application will be briefly explained.

1. Configured Grant (CG)

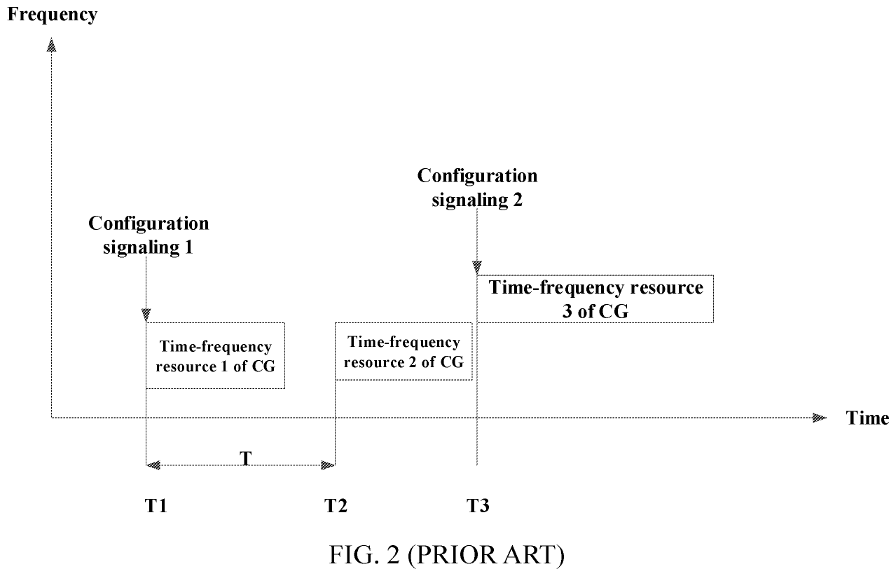

As shown in FIG. 2, at a time T1, a network configures a CG for UE through configuration signaling 1 with a repetition period of T, such as a time-frequency resource 1 and a time-frequency resource 2 of the CG. The network can adjust configuration parameters such as an allocated CG time-frequency resource and/or a period when necessary. As shown in FIG. 2, at a time T3, the network adjusts, by sending configuration signaling 2, a time-frequency location of the CG resource and a Transport Block Size (TBS) that can be carried, as shown in a time-frequency resource 3 of the CG.

There are two types of CG, a type1 CG and a type2 CG. The type1 CG realizes configuration and activation of the CG resource through a piece of Radio Resource Control (RRC) signaling; and the type2 CG realizes configuration of the CG resource through a piece of RRC signaling, and then realizes activation of the CG resource through a piece of Physical Downlink Control Channel (PDCCH) scheduling signaling. That is, the type1 CG is only configured or reconfigured based on RRC, and does not need any L1 signaling for activation and deactivation. A configuration parameter of the type2 CG needs to be configured jointly by RRC and L1 signaling. In addition, the L1 signaling is also used to activate or deactivate the CG resource.

For the type1 CG, the parameter configured or reconfigured based on RRC includes:
1) a repetition period of a scheduled resource;
2) resource allocation in time domain;
3) resource allocation in frequency domain;
4) a sequence configured by a UE-specific Demodulation Reference Signal (DMRS) (for example, a Reference Signal (RS)), Orthogonal Cover Code (OCC), and/or Cyclic Shift (CS), and the like;
5) one Modulation and Coding Scheme (MCS) or a Transport Block Size (TBS);
6) a quantity K of repetitions; and
7) a parameter related to power control (such as P0, alpha, and the like).

For the type2 CG, the parameter configured or reconfigured based on RRC includes:
1) a repetition period of a scheduled resource; and
2) a parameter related to power control.

The parameter configured or reconfigured based on L1 signaling includes:
1) an offset relative to a reference timing;
2) a time-domain location of a resource;
3) a frequency-domain location of a resource;
4) a UE-specific DMRS configuration; and
5) one MCS or TBS.

2. CG on an Unlicensed Band

In NR, the network can specify, for a CG resource configured by the network for the UE on the unlicensed band, one or more Hybrid Automatic Repeat reQuest (HARQ) process numbers associated with the CG configuration. For each time-frequency resource block of a CG, the UE can select one of the HARQ processes (for example, HPID=n; HPID is HARQ Process ID) for transmission. The transmission may be an initial transmission or a retransmission.

If the CG is used for retransmission, the following conditions need to be met:
1) a TBS of the CG time-frequency resource block needs to be the same as a TBS in an HARQ buffer with HPID=n; and
2) a previous time of transmission with HPID=n is not performed by using a dynamically scheduled resource (that is, the transmission is performed by using the CG).

3. Priority of a CG Time-Frequency Resource

The priority of a time-frequency resource of the CG is determined by a priority of data mapped to the time-frequency resource for transmission, and details are as follows:
1) for initial transmission data: among all logical channels that can be mapped to the CG resource for transmission, a priority of a logical channel with a highest priority and having data to be transmitted is selected as the priority of the CG resource; and

The network may configure a priority for each uplink logical channel of the UE.

At a specific moment, the network may allocate an uplink resource for the UE, but at this moment, the UE may have no data to transmit. For example, for VOIP, the network allocates a resource to the UE every 20 ms, but the UE is silent at a specific moment (the other party is talking), so there is no data to be transmitted. If there is no data to be transmitted, the priority of the resource is considered to be lower than that of any resource with data to be transmitted.
2) for retransmission data: among all logical channels multiplexed by a Transport Block (TB) to be retransmitted, a priority of the logical channel with the highest priority is the priority of the CG resource.

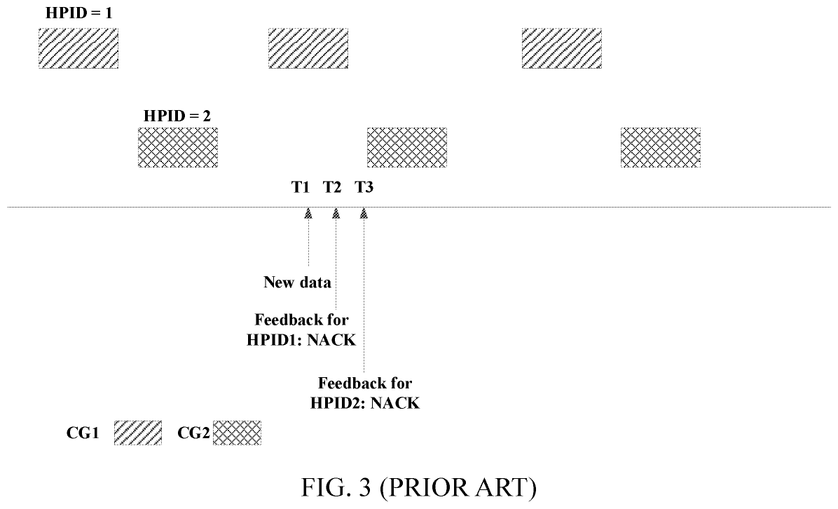

As shown in FIG. 3, the network allocates two groups of CG resources to the UE: a CG1 resource and a CG2 resource. The UE is used to transmit HPID1 and HPID2 (HPIDn represents an HARQ process with HPID=n) respectively. At the time T1, new data arrives at an access layer of the UE, to be transmitted; at a time T2, the UE receives feedback from the network for the HPID1: negative ACKnowledge (NACK), that is, data in an HPID1 buffer needs to be retransmitted; and at a time T3, the UE receives feedback from the network for the HPID2: NACK, that is, data in an HPID2 buffer needs to be retransmitted.

In FIG. 3, a start time of a second resource block of CG1 is earlier than T1, that is, neither new data nor data to be retransmitted can be mapped to this resource block for transmission. However, the start time of the second resource block of CG2 is later than T3, that is, both the new data and the data to be retransmitted can be mapped to this resource block for transmission (it should be noted that a TBS of data in the HPID1/2 buffer is assumed to be the same as that of CG2).

Then, how to determine which of the following data can be transferred on the second resource block of CG2:
retransmission data corresponding to HPID1;
retransmission data corresponding to HPID2; and
newly transmitted data corresponding to HPID3 (assuming that HPID3 can be used for new transmission on the second resource block of CG2).

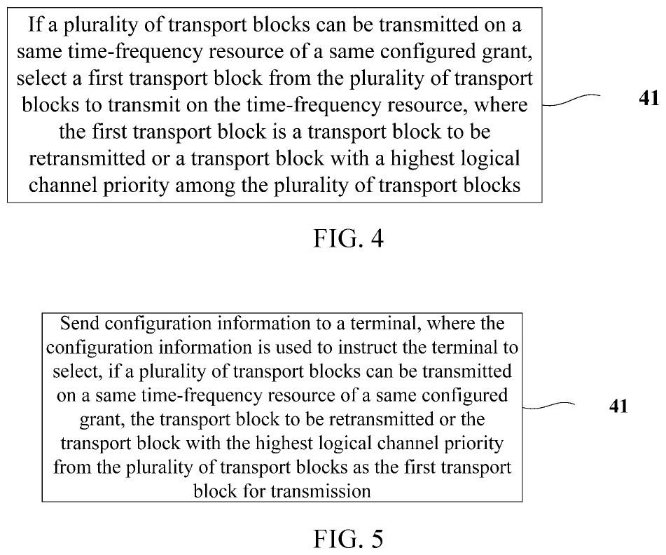

To resolve the foregoing technical problems, refer to FIG. 4, this application provides an uplink data sending method, executed by a terminal, and including the following steps.

Step 41: If a plurality of transport blocks can be transmitted on a same time-frequency resource of a same configured grant, select a first transport block from the plurality of transport blocks to transmit on the time-frequency resource, where the first transport block is a transport block to be retransmitted or a transport block with a highest logical channel priority among the plurality of transport blocks.

In this embodiment of this application, the transport block may include retransmission data and/or initial transmission data. For the retransmission data, the data has been packaged into a Media Access Control (MAC) Protocol Data Unit (PDU) and stored in the HARQ buffer, so it can be referred to as a generated MAC PDU; and for the initial transmission data, no PDU is generated until it is determined that a resource can be obtained, otherwise, a TBS of a resource that should be allocated to the PDU cannot be determined, and a generated PDU does not match a TBS of a resource to be allocated for PDU transmission, so the MAC PDU is not generated at this time, which can be referred to as a MAC PDU to be generated.

In this embodiment of this application, one transport block can carry data from at least one logical channel, and each logical channel has its own priority. It is assumed that a TB1 carries data from three logical channels: 1, 2, and 3, where a priority of the logical channel 1 is A, a priority of the logical channel 2 is A, and a priority of the logical channel 3 is B.

A transport block with a highest logical channel priority among a plurality of transport blocks means comparing priorities of logical channels with the highest priority of each transport block, and a transport block corresponding to a logical channel with the highest priority is the transport block with the highest logical channel priority. For example, it is assumed that TB1 is compared with TB2, TB1 carries data from three logical channels: 1, 2, and 3, where a priority of the logical channel 1 is A, a priority of the logical channel 2 is B, and a priority of the logical channel 3 is C, TB2 carries data from three logical channels: 4, 5, and 6, where a priority of the logical channel 4 is B, a priority of the logical channel 5 is B, and a priority of the logical channel 6 is C, a highest priority of a logical channel of TB1 is A, and a highest priority of a logical channel of TB2 is B. So it can be concluded that the transport block with the highest logical channel priority between TB1 and TB2 is TB1. Here, it is assumed that a relative relationship of priority A/B/C is: the priority A is higher than the priority B, and the priority B is higher than the priority C.

In this embodiment of this application, it is specified that when a plurality of transport blocks of the terminal can be transmitted on a same time-frequency resource of a same configured grant, how the terminal selects a transport block carried on the time-frequency resource of the configured grant, so as to meet priority requirements and/or delay requirements of a service.

In the following, two selection manners in which the first transport block is the transport block to be retransmitted among the plurality of transport blocks, and the first transport block is the transport block with the highest logical channel priority are explained respectively.

(1) The first transport block is the transport block to be retransmitted among the plurality of transport blocks.

In some embodiments, the selecting a first transport block from the plurality of transport blocks to transmit on the time-frequency resource includes: if there are a plurality of transport blocks to be retransmitted among the plurality of transport blocks, selecting, from the plurality of transport blocks to be retransmitted, the transport block with the highest logical channel priority as the first transport block. In other words, when the transport block to be transmitted is selected from the plurality of transport blocks, the transport block to be retransmitted has priority, and if there are a plurality of transport blocks to be retransmitted, logical channel priorities of the plurality of transport blocks to be retransmitted are considered.

In some embodiments, the selecting, from the plurality of transport blocks to be retransmitted, the transport block with the highest logical channel priority as the first transport block includes:
if the plurality of transport blocks to be retransmitted include a plurality of transport blocks to be retransmitted with equal and highest logical channel priorities, selecting, from the plurality of transport blocks to be retransmitted with equal and highest logical channel priorities, one transport block as the first transport block according to at least one of the following rules:
1) selecting, from the plurality of transport blocks to be retransmitted with equal and highest logical channel priorities, a transport block with a maximum number of retransmissions as the first transport block;

The larger the number of retransmissions is, the more eager the transport block is to be transmitted, so the transport block with the maximum number of retransmissions is selected as the first transport block.
2) obtaining priorities corresponding to logical channels with second highest priorities among the plurality of transport blocks to be retransmitted with equal and highest logical channel priorities, selecting a first logical channel with a highest priority from the logical channels with the second highest priorities, and using a transport block to be retransmitted corresponding to the first logical channel as the first transport block;

For example, it is assumed that TB1 carries data from three logical channels, TB2 carries data from three logical channels, the highest priority among the three logical channels of TB1 is A, and the highest priority among the three logical channels of TB2 is also A, then it is necessary to compare priorities of second highest logical channels of TB1 and TB2. It is assumed that priorities of remaining two logical channels of TB1 are A and B respectively, and priorities of remaining two logical channels of TB2 are B and C respectively. In this case, the second highest priority of TB1 is A, and the second highest priority of TB2 is B. In this case, TB1 is selected for transmission.
3) selecting, from the plurality of transport blocks to be retransmitted with equal and highest logical channel priorities, a transport block with a largest or smallest HARQ process identifier as the first transport block;
4) selecting, from the plurality of transport blocks to be retransmitted with equal and highest logical channel priorities, a transport block with a latest or earliest transmission failure as the first transport block; and
5) selecting, from the plurality of transport blocks to be retransmitted with equal and highest logical channel priorities, a transport block carrying a MAC Control Element (CE) as the first transport block.

The MAC CE is control signaling of a MAC layer, and it is generally considered that the control signaling has a higher priority, so the transport block carrying the MAC CE can be used as the first transport block.

In this embodiment of this application, the rules are determined by the terminal, or configured by a network side, or specified by a protocol.

(2) The first transport block is a transport block with the highest logical channel priority among the plurality of transport blocks.

In some embodiments, the selecting a first transport block from the plurality of transport blocks to transmit on the time-frequency resource includes:
if there are a plurality of transport blocks with the highest logical channel priority among the plurality of transport blocks, selecting one transport block from the plurality of transport blocks with the highest logical channel priority as the first transport block according to at least one of the following rules:
1) obtaining priorities corresponding to logical channels with second highest priorities among the plurality of transport blocks with the highest logical channel priority, selecting a first logical channel with a highest priority from the logical channels with the second highest priorities, and using a transport block corresponding to the first logical channel as the first transport block;
2) selecting, from the plurality of transport blocks with the highest logical channel priority, a transport block to be retransmitted as the first transport block;
3) selecting, from the plurality of transport blocks with the highest logical channel priority, a transport block with a largest or smallest HARQ process identifier as the first transport block; and
4) selecting, from the plurality of transport blocks with the highest logical channel priority, a transport block carrying a MAC CE as the first transport block.

In this embodiment of this application, the rules are determined by the terminal, or configured by a network side, or specified by a protocol.

In some embodiments, the selecting, from the plurality of transport blocks with the highest logical channel priority, a transport block to be retransmitted as the first transport block includes:
if there are a plurality of transport blocks to be retransmitted among the plurality of transport blocks with the highest logical channel priority, selecting one transport block from the plurality of transport blocks to be retransmitted as the first transport block according to at least one of the following rules:
1) obtaining priorities corresponding to logical channels with second highest priorities among the plurality of transport blocks to be retransmitted, selecting a first logical channel with a highest priority from the logical channels with the second highest priorities, and using a transport block to be retransmitted corresponding to the first logical channel as the first transport block;
2) selecting, from the plurality of transport blocks to be retransmitted, a transport block with a maximum number of retransmissions as the first transport block;
3) selecting, from the plurality of transport blocks to be retransmitted, a transport block with a largest or smallest HARQ process identifier as the first transport block;
4) selecting, from the plurality of transport blocks to be retransmitted, a transport block with a latest or earliest transmission failure as the first transport block; and
5) selecting, from the plurality of transport blocks to be retransmitted, a transport block carrying a MAC CE as the first transport block.

In this embodiment of this application, the rules are determined by the terminal, or configured by a network side, or specified by a protocol.

In some embodiments, whether to select the transport block to be retransmitted or the transport block with the highest logical channel priority as the first transport block is determined by the protocol.

In some embodiments, whether to select the transport block to be retransmitted or the transport block with the highest logical channel priority as the first transport block is configured by the network side.

When it is configured by the network, the method further includes:
receiving configuration information sent from a network side, where the configuration information is used to instruct the terminal to select, if a plurality of transport blocks can be transmitted on a same time-frequency resource of a same configured grant, the transport block to be retransmitted or the transport block with the highest logical channel priority from the plurality of transport blocks as the first transport block for transmission.

In some embodiments, the configuration information is carried through RRC signaling.

In some embodiments, the configuration information is configuration information for per CG configuration; and if there are two CG configurations: CG1 and CG2, the network side can configure the foregoing configuration information for CG1 and CG2 respectively; or
the configuration information is configuration information for per MAC entity; and dual-connected UE may be connected to two base stations, a UE side has a corresponding MAC entity for each base station, and the network side can separately configure the foregoing configuration information for the two MAC entities on the UE side, for example, for a MAC entity corresponding to a base station 1, the transport block to be retransmitted is selected as the first transport block, and for a MAC entity corresponding to a base station 2, the transport block with the highest logical channel priority is selected as the first transport block; or
the configuration information is configuration information for per cell group; or
the configuration information is configuration information for per cell.

In some embodiments, the time-frequency resource is an unlicensed band resource. The time-frequency resource can also be other types of resources.

Refer to FIG. 5, an embodiment of this application further provides an uplink data sending configuration method, executed by a network side device, and including the following steps.

Step 51: Send configuration information to a terminal, where the configuration information is used to instruct the terminal to select, if a plurality of transport blocks can be transmitted on a same time-frequency resource of a same configured grant, the transport block to be retransmitted or the transport block with the highest logical channel priority from the plurality of transport blocks as the first transport block for transmission.

In some embodiments, the configuration information is carried through RRC signaling.

In some embodiments, the configuration information is configuration information for per CG configuration, or for per MAC entity, or for per cell group, or for per cell.

With reference to specific embodiments, the following describes the uplink data sending method in this application with examples.

Embodiment 1 of the present application: retransmission is in priority.

FIG. 3 is used as an example again, and the uplink data sending method in this application includes the following steps.

Step S1: UE receives configuration information of CG1 and CG2 on the network side to obtain a configuration of CG1 and CG2.

Step S2: The UE uses CG1 and HPID1 for TB1 transmission; and the UE uses CG2 and HPID2 for TB2 transmission.

At a time T1, new data arrives at an access layer of the UE, to be transmitted;
at a time T2, the UE receives feedback from the network side for the HPID1: NACK, that is, data in an HPID1 buffer needs to be retransmitted; and
at a time T3, the UE receives feedback from the network side for the HPID2: NACK, that is, data in an HPID2 buffer needs to be retransmitted.

In this embodiment of this application, retransmission is in priority, and data in the HPID1 buffer or data in the HPID2 buffer can be selected. Since there are two pieces of retransmission data, the UE selects a TB with the highest logical channel priority from TBs to be retransmitted (TB1 and TB2) to transmit in a second resource block of CG2: if the priority of the logical channel with the highest priority in TB1 is X, the priority of the logical channel with the highest priority in TB2 is Y, and the priority of X is higher than Y, the UE selects TB1 for transmission.

Embodiment 2 of the present application: high logical channel priority is in priority.

FIG. 3 is used as an example again, and the uplink data sending method in this application includes the following steps.

Step S1: UE receives configuration information of CG1 and CG2 on the network side to obtain a configuration of CG1 and CG2.

Step S2: The UE uses CG1 and HPID1 for TB1 transmission; and the UE uses CG2 and HPID2 for TB2 transmission.

At a time T1, new data arrives at an access layer of the UE, to be transmitted;
at a time T2, the UE receives feedback from the network side for the HPID1: NACK, that is, data in an HPID1 buffer needs to be retransmitted; and
at a time T3, the UE receives feedback from the network side for the HPID2: NACK, that is, data in an HPID2 buffer needs to be retransmitted.

The UE selects data with the highest logical channel priority from the TBs to be retransmitted (TB1 and TB2) and data to be initially transmitted to transmit in the second resource block of CG2:
the priority of the logical channel with the highest priority in TB1 is X;
the priority of the logical channel with the highest priority in TB2 is Y;
among new data to be transmitted that can be mapped to the second resource block of CG2 for transmission, a priority of a logical channel with the highest priority is Z; and
the UE selects data corresponding to the logical channel with the highest priority among X, Y, Z for transmission: that is, if the priority of X is the highest, TB1 is selected for transmission; if the priority of Y is the highest, TB2 is selected for transmission; and if the priority of Z is the highest, TB3 is selected for transmission.

Further, if priorities of the logical channels with the highest priority are the same, retransmission is in priority or a larger number of retransmissions is in priority.

Embodiment 3 of the present application: corresponding to same highest logical channel priorities.

Based on Embodiment 1 and Embodiment 2, after comparison, if the UE finds that among all TBs, the priority of the logical channel with the highest priority is X, and priorities of logical channels with the highest priority in a plurality of TBs are all X, the UE compares priorities of logical channels with second highest priorities among all the TBs with the highest logical channel priority of X, and selects a TB corresponding to a logical channel with the highest priority among the logical channels with the second highest priorities for transmission.

In the embodiments of this application, selecting TB and selecting the HARQ process corresponding to the TB have the same meaning, and can also be expressed as selecting the HARQ process for transmission.

It should be noted that an execution subject of the uplink data sending method according to an embodiment of this application may be an uplink data sending apparatus, or a control module for performing the uplink data sending method in the uplink data sending apparatus. In this embodiment of this application, the uplink data sending apparatus according to an embodiment of this application is described by using an example in which the uplink data sending apparatus performs the uplink data sending method.

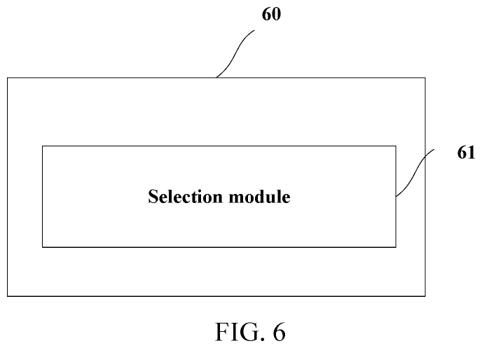

Refer to FIG. 6, an embodiment of this application further provides an uplink data sending apparatus, including:
a selection module 61, configured to: if a plurality of transport blocks can be transmitted on a same time-frequency resource of a same configured grant, select a first transport block from the plurality of transport blocks to transmit on the time-frequency resource, where the first transport block is a transport block to be retransmitted or a transport block with a highest logical channel priority among the plurality of transport blocks.

In some embodiments, the first transport block is the transport block to be retransmitted among the plurality of transport blocks; and the selection module includes:
a first selection submodule, configured to: if there are a plurality of transport blocks to be retransmitted among the plurality of transport blocks, select, from the plurality of transport blocks to be retransmitted, the transport block with the highest logical channel priority as the first transport block.

In some embodiments, the first selection submodule is configured to: if the plurality of transport blocks to be retransmitted include a plurality of transport blocks to be retransmitted with equal and highest logical channel priorities, select, from the plurality of transport blocks to be retransmitted with equal and highest logical channel priorities, one transport block as the first transport block according to at least one of the following rules:
selecting, from the plurality of transport blocks to be retransmitted with equal and highest logical channel priorities, a transport block with a maximum number of retransmissions as the first transport block;
obtaining priorities corresponding to logical channels with second highest priorities among the plurality of transport blocks to be transmitted with the highest logical channel priority, selecting a first logical channel with a highest priority from the logical channels with the second highest priorities, and using a transport block to be transmitted corresponding to the first logical channel as the first transport block;
selecting, from the plurality of transport blocks to be retransmitted with equal and highest logical channel priorities, a transport block with a largest or smallest HARQ process identifier as the first transport block;
selecting, from the plurality of transport blocks to be retransmitted with equal and highest logical channel priorities, a transport block with a latest or earliest transmission failure as the first transport block; and
selecting, from the plurality of transport blocks to be retransmitted with equal and highest logical channel priorities, a transport block carrying a MAC CE as the first transport block.

In some embodiments, the rules are determined by the terminal, or configured by a network side, or specified by a protocol.

In some embodiments, the first transport block is a transport block with the highest logical channel priority among the plurality of transport blocks; and the selection module includes:
a second selection submodule, configured to: if there are a plurality of transport blocks with the highest logical channel priority among the plurality of transport blocks, select one transport block from the plurality of transport blocks with the highest logical channel priority as the first transport block according to at least one of the following rules:
obtaining priorities corresponding to logical channels with second highest priorities among the plurality of transport blocks with the highest logical channel priority, selecting a first logical channel with a highest priority from the logical channels with the second highest priorities, and using a transport block corresponding to the first logical channel as the first transport block;
selecting, from the plurality of transport blocks with the highest logical channel priority, a transport block to be retransmitted as the first transport block;
selecting, from the plurality of transport blocks with the highest logical channel priority, a transport block with a largest or smallest HARQ process identifier as the first transport block; and
selecting, from the plurality of transport blocks with the highest logical channel priority, a transport block carrying a MAC CE as the first transport block.

In some embodiments, the rules are determined by the terminal, or configured by a network side, or specified by a protocol.

In some embodiments, the second selection submodule is configured to: if there are a plurality of transport blocks to be retransmitted among the plurality of transport blocks with the highest logical channel priority, select one transport block from the plurality of transport blocks to be retransmitted as the first transport block according to at least one of the following rules:
obtaining priorities corresponding to logical channels with second highest priorities among the plurality of transport blocks to be retransmitted, selecting a first logical channel with a highest priority from the logical channels with the second highest priorities, and using a transport block to be retransmitted corresponding to the first logical channel as the first transport block;
selecting, from the plurality of transport blocks to be retransmitted, a transport block with a maximum number of retransmissions as the first transport block;
selecting, from the plurality of transport blocks to be retransmitted, a transport block with a largest or smallest HARQ process identifier as the first transport block;
selecting, from the plurality of transport blocks to be retransmitted, a transport block with a latest or earliest transmission failure as the first transport block; and
selecting, from the plurality of transport blocks to be retransmitted, a transport block carrying a MAC CE as the first transport block.

In some embodiments, the rules are determined by the terminal, or configured by a network side, or specified by a protocol.

In some embodiments, it is specified by a protocol that a transport block to be retransmitted or a transport block with the highest logical channel priority is selected from the plurality of transport blocks as the first transport block.

In some embodiments, the apparatus further includes:
a receiving module, configured to receive configuration information sent from a network side, where the configuration information is used to instruct the terminal to select, if a plurality of transport blocks can be transmitted on a same time-frequency resource of a same configured grant, the transport block to be retransmitted or the transport block with the highest logical channel priority from the plurality of transport blocks as the first transport block for transmission.

In some embodiments, the configuration information is carried through RRC signaling.

In some embodiments, the configuration information is configuration information for per CG configuration, or for per MAC entity, or for per cell group, or for per cell.

In some embodiments, the time-frequency resource is an unlicensed band resource.

The uplink data sending apparatus in this embodiment of this application may be an apparatus, or may be a component, an integrated circuit, or a chip in a terminal. The apparatus may be a mobile terminal, or a non-mobile terminal. For example, the mobile terminal may include but is not limited to the types of the terminal 11 listed above, and the non-mobile terminal may be a server, a Network Attached Storage (NAS), a Personal Computer (PC), a television (TV), an automated teller machine, or a self-service machine. This is not specifically limited in the embodiments of this application.

The uplink data sending apparatus in this embodiment of this application may be an apparatus with an operating system. The operating system may be an Android operating system, may be an iOS operating system, or may be another possible operating system. This is not specifically limited in this embodiment of this application.

The uplink data sending apparatus provided in this embodiment of this application can implement the processes implemented in the method embodiment shown in FIG. 4, and achieve a same technical effect. To avoid repetition, details are not provided herein again.

It should be noted that an execution subject of the uplink data sending configuration method according to an embodiment of this application may be an uplink data sending configuration apparatus, or a control module for performing the uplink data sending configuration method in the uplink data sending configuration apparatus. In this embodiment of this application, the uplink data sending configuration apparatus according to an embodiment of this application is described by using an example in which the uplink data sending configuration apparatus performs the uplink data sending configuration method.

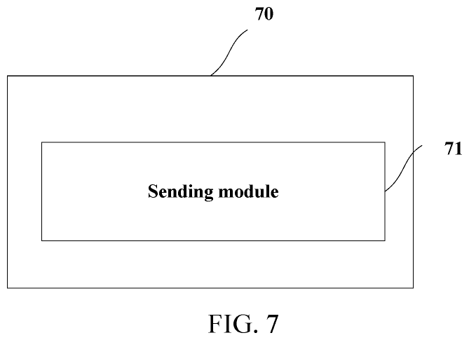

Refer to FIG. 7, an embodiment of this application further provides an uplink data sending configuration apparatus 70, including:
a sending module 71, configured to send configuration information to a terminal, where the configuration information is used to instruct the terminal to select, if a plurality of transport blocks can be transmitted on a same time-frequency resource of a same configured grant, the transport block to be retransmitted or the transport block with the highest logical channel priority from the plurality of transport blocks as the first transport block for transmission.

In some embodiments, the configuration information is carried through RRC signaling.

In some embodiments, the configuration information is configuration information for per CG configuration, or for per MAC entity, or for per cell group, or for per cell.

The uplink data sending apparatus provided in this embodiment of this application can implement the processes implemented in the method embodiment shown in FIG. 5, and achieve a same technical effect. To avoid repetition, details are not provided herein again.

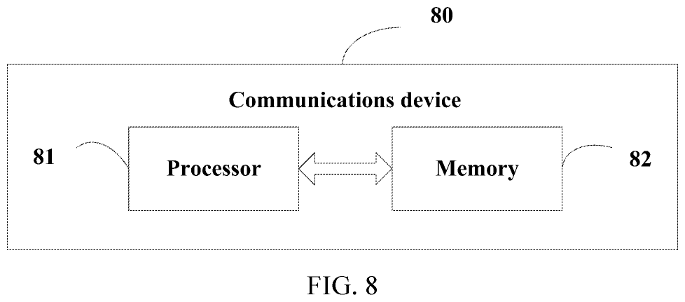

As shown in FIG. 8, an embodiment of this application further provides a communications device 80, including a processor 81, a memory 82, and a program or an instruction stored in the memory 82 and executable on the processor 81. For example, in a case that the communications device 80 is a terminal, the program or the instruction, when executed by the processor 81, implements the processes of the embodiment of the uplink data sending method, and a same technical effect can be achieved. When the communications device 80 is a network side device, and the programs or the instruction is executed by the processor 81, the processes of the embodiment of the uplink data sending configuration method are performed, and a same technical effect can be achieved. To avoid repetition, details are not repeated herein again.

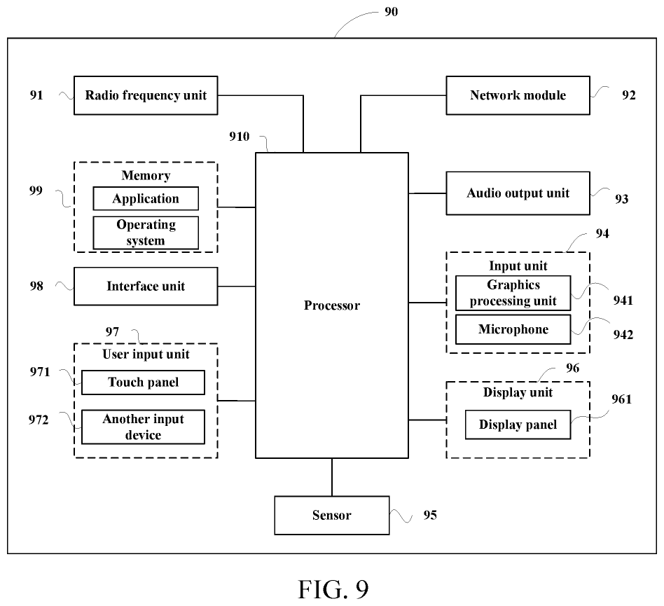

FIG. 9 is a schematic diagram of a hardware structure of a terminal according to an embodiment of this application. The terminal 90 includes but is not limited to components such as a radio frequency unit 91, a network module 92, an audio output unit 93, an input unit 94, a sensor 95, a display unit 96, a user input unit 97, an interface unit 98, a memory 99, and a processor 910.

A person skilled in the art can understand that the terminal 90 may further include a power supply (such as a battery) that supplies power to each component. The power supply may be logically connected to the processor 910 by using a power supply management system, to implement functions such as charging and discharging management, and power consumption management by using the power supply management system. The terminal structure shown in FIG. 9 constitutes no limitation on the terminal, and the terminal may include more or fewer components than those shown in the figure, or combine some components, or have different component arrangements. Details are not described herein.

It should be understood that, in the embodiments of this application, the input unit 94 may include a Graphics Processing Unit (GPU) 941 and a microphone 942, and the graphics processing unit 941 processes image data of a still picture or video obtained by an image capture apparatus (such as a camera) in a video capture mode or an image capture mode. The display unit 96 may include a display panel 961, and the display panel 961 may be configured in a form of a liquid crystal display, an organic light emitting diode, or the like. The user input unit 97 includes a touch panel 971 and another input device 972. The touch panel 971 is also referred to as a touchscreen. The touch panel 971 may include two parts: a touch detection apparatus and a touch controller. The another input device 972 may include but is not limited to a physical keyboard, a functional button (such as a volume control button or a power on/off button), a trackball, a mouse, and a joystick. Details are not described herein.

In this embodiment of this application, the radio frequency unit 91 receives downlink data from a network side device and then sends the downlink data to the processor 910 for processing; and sends uplink data to the network side device. Generally, the radio frequency unit 91 includes but is not limited to an antenna, at least one amplifier, a transceiver, a coupler, a low noise amplifier, a duplexer, and the like.

The memory 99 may be configured to store a software program or an instruction and various data. The memory 99 may mainly include a program or instruction storage area and a data storage area. The program or instruction storage area may store an operating system, and an application or an instruction required by at least one function (for example, a sound playing function or an image playing function). In addition, the memory 99 may include a high-speed random access memory, and may further include a non-volatile memory. The non-volatile memory may be a Read-only Memory (ROM), a Programmable ROM (PROM), an Erasable PROM (EPROM), an Electrically EPROM (EEPROM), or a flash memory, for example, at least one disk storage device, a flash memory device, or another non-volatile solid-state storage device.

The processor 910 may include one or more processing units. In some embodiments, an application processor and a modem processor may be integrated into the processor 910. The application processor mainly processes an operating system, a user interface, an application, an instruction, or the like. The modem processor mainly processes wireless communications, for example, a baseband processor.

It can be understood that, the modem processor may not be integrated into the processor 910.

The processor 910 is configured to: if a plurality of transport blocks can be transmitted on a same time-frequency resource of a same configured grant, select a first transport block from the plurality of transport blocks to transmit on the time-frequency resource, where the first transport block is a transport block to be retransmitted or a transport block with a highest logical channel priority among the plurality of transport blocks.

In this embodiment of this application, it is specified that when a plurality of transport blocks of the terminal can be transmitted on a same time-frequency resource of a same configured grant, how the terminal selects a transport block carried on the time-frequency resource of the configured grant, so as to meet priority requirements and/or delay requirements of a service.

In some embodiments, the first transport block is the transport block to be retransmitted among the plurality of transport blocks; and the processor 910 is configured to: if there are a plurality of transport blocks to be retransmitted among the plurality of transport blocks, select, from the plurality of transport blocks to be retransmitted, the transport block with the highest logical channel priority as the first transport block.

In some embodiments, the processor 910 is configured to: if the plurality of transport blocks to be retransmitted include a plurality of transport blocks to be retransmitted with equal and highest logical channel priorities, select, from the plurality of transport blocks to be retransmitted with equal and highest logical channel priorities, one transport block as the first transport block according to at least one of the following rules:
selecting, from the plurality of transport blocks to be retransmitted with equal and highest logical channel priorities, a transport block with a maximum number of retransmissions as the first transport block;
obtaining priorities corresponding to logical channels with second highest priorities among the plurality of transport blocks to be retransmitted with equal and highest logical channel priorities, selecting a first logical channel with a highest priority from the logical channels with the second highest priorities, and using a transport block to be retransmitted corresponding to the first logical channel as the first transport block;
selecting, from the plurality of transport blocks to be retransmitted with equal and highest logical channel priorities, a transport block with a largest or smallest HARQ process identifier as the first transport block;
selecting, from the plurality of transport blocks to be retransmitted with equal and highest logical channel priorities, a transport block with a latest or earliest transmission failure as the first transport block; and
selecting, from the plurality of transport blocks to be retransmitted with equal and highest logical channel priorities, a transport block carrying a MAC CE as the first transport block.

In some embodiments, the first transport block is a transport block with the highest logical channel priority among the plurality of transport blocks; and the processor 910 is configured to: if there are a plurality of transport blocks with the highest logical channel priority among the plurality of transport blocks, select one transport block from the plurality of transport blocks with the highest logical channel priority as the first transport block according to at least one of the following rules:
obtaining priorities corresponding to logical channels with second highest priorities among the plurality of transport blocks with the highest logical channel priority, selecting a first logical channel with a highest priority from the logical channels with the second highest priorities, and using a transport block corresponding to the first logical channel as the first transport block;
selecting, from the plurality of transport blocks with the highest logical channel priority, a transport block to be retransmitted as the first transport block;
selecting, from the plurality of transport blocks with the highest logical channel priority, a transport block with a largest or smallest HARQ process identifier as the first transport block; and
selecting, from the plurality of transport blocks with the highest logical channel priority, a transport block carrying a MAC CE as the first transport block.

In some embodiments, the processor 910 is configured to: if there are a plurality of transport blocks to be retransmitted among the plurality of transport blocks with the highest logical channel priority, select one transport block from the plurality of transport blocks to be retransmitted as the first transport block according to at least one of the following rules:
obtaining priorities corresponding to logical channels with second highest priorities among the plurality of transport blocks to be retransmitted, selecting a first logical channel with a highest priority from the logical channels with the second highest priorities, and using a transport block to be retransmitted corresponding to the first logical channel as the first transport block;
selecting, from the plurality of transport blocks to be retransmitted, a transport block with a maximum number of retransmissions as the first transport block;
selecting, from the plurality of transport blocks to be retransmitted, a transport block with a largest or smallest HARQ process identifier as the first transport block;
selecting, from the plurality of transport blocks to be retransmitted, a transport block with a latest or earliest transmission failure as the first transport block; and
selecting, from the plurality of transport blocks to be retransmitted, a transport block carrying a MAC CE as the first transport block.

In some embodiments, the rules are determined by the terminal, or configured by a network side, or specified by a protocol.

In some embodiments, it is specified by a protocol that a transport block to be retransmitted or a transport block with the highest logical channel priority is selected from the plurality of transport blocks as the first transport block.

In some embodiments, the radio frequency unit 91 is configured to: receive configuration information sent from a network side, where the configuration information is used to instruct the terminal to select, if a plurality of transport blocks can be transmitted on a same time-frequency resource of a same configured grant, the transport block to be retransmitted or the transport block with the highest logical channel priority from the plurality of transport blocks as the first transport block for transmission.

In some embodiments, the configuration information is carried through RRC signaling.

In some embodiments, the configuration information is configuration information for per CG configuration, or for per MAC entity, or for per cell group, or for per cell.

In some embodiments, the time-frequency resource is an unlicensed band resource.

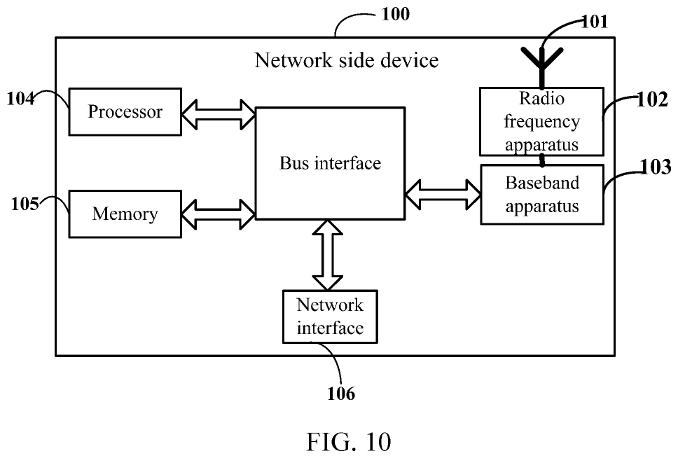

An embodiment of this application further provides a network side device. As shown in FIG. 10, the network side device 100 includes an antenna 101, a radio frequency apparatus 102, and a baseband apparatus 103. The antenna 101 is connected to the radio frequency apparatus 102. In an uplink direction, the radio frequency apparatus 102 receives information through the antenna 101, and sends the received information to the baseband apparatus 103 for processing. In a downlink direction, the baseband apparatus 103 processes information to be sent and sends the information to the radio frequency apparatus 102, and the radio frequency apparatus 102 processes the received information and sends the information through the antenna 101.

The foregoing band processing apparatus may be located in the baseband apparatus 103, and the method performed by the network side device in the foregoing embodiment may be implemented in the baseband apparatus 103. The baseband apparatus 103 includes a processor 104 and a memory 105.

The baseband apparatus 103 may include, for example, at least one baseband board. A plurality of chips are disposed on the baseband board. As shown in FIG. 10, one chip is, for example, the processor 104, connected to the memory 105, to invoke a program in the memory 105, thereby performing operations of the network device shown in the foregoing method embodiment.

The baseband apparatus 103 may further include a network interface 106, configured to exchange information with the radio frequency apparatus 102, where the interface is, for example, a Common Public Radio Interface (CPRI).

The network side device in embodiments of the present application further includes an instruction or a program stored in the memory 105 and executable on the processor 104. The processor 104 invokes the instruction or the program in the memory 105 to perform the method performed by the modules shown in FIG. 7, and a same technical effect is achieved. To avoid repetition, details are not provided herein again.

An embodiment of this application further provides a readable storage medium. The readable storage medium stores a program or an instruction, and when the program or the instruction is executed by a processor, the processes of the embodiment of the uplink data sending method are implemented and a same technical effect can be achieved. To avoid repetition, details are not described herein again.

An embodiment of this application further provides a readable storage medium. The readable storage medium stores a program or an instruction, and when the program or the instruction is executed by a processor, the processes of the embodiment of the uplink data sending configuration method are implemented and a same technical effect can be achieved. To avoid repetition, details are not described herein again.

The processor is a processor in the terminal in the foregoing embodiment. The readable storage medium includes a computer-readable storage medium, such as a computer ROM, an RAM, a magnetic disk, or an optical disc.

An embodiment of this application also provides a chip, where the chip includes a processor and a communications interface, and the communications interface is coupled to the processor. The processor is configured to run a program or an instruction of a network side device to implement the processes of the embodiment of the uplink data sending method, and a same technical effect can be achieved. To avoid repetition, details are not described herein again.

An embodiment of this application also provides a chip, where the chip includes a processor and a communications interface, and the communications interfaces is coupled to the processor. The processor is configured to run a program or an instruction of a network side device to implement the processes of the embodiment of the uplink data sending configuration method, and a same technical effect can be achieved. To avoid repetition, details are not described herein again.

It should be understood that the chip mentioned in this embodiment of this application may also be referred to as a system-level chip, a system chip, a chip system, or an on-chip system chip.

An embodiment of this application also provides a computer program product, the computer program product is stored in a non-volatile storage medium, the computer program product is executed by at least one processor to implement the processes of the embodiment of the uplink data sending method, and a same technical effect can be achieved. To avoid repetition, details are not described herein again.

An embodiment of this application also provides a computer program product, the computer program product is stored in a non-volatile storage medium, the computer program product is executed by at least one processor to implement the processes of the embodiment of the uplink data sending configuration method, and a same technical effect can be achieved. To avoid repetition, details are not described herein again.

It should be noted that in this specification, the term “include”, “comprise”, or any other variant is intended to cover a non-exclusive inclusion, so that a process, method, article, or apparatus that includes a series of elements includes not only those elements but also other elements that are not explicitly listed, or includes elements inherent to such a process, method, article, or apparatus. An element limited by “includes a . . . ” does not, without more constraints, preclude the presence of additional identical elements in the process, method, article, or apparatus that includes the element. In addition, it should be noted that a scope of the method and the apparatus in the implementations of this application is not limited to: performing a function in a sequence shown or discussed, and may further include: performing a function in a basically simultaneous manner or in a reverse sequence based on an involved function. For example, the described method may be performed in a different order, and various steps may be added, omitted, or combined. In addition, features described with reference to some examples may be combined in other examples.

Based on the descriptions of the foregoing implementations, a person skilled in the art may clearly understand that the method in the foregoing embodiments may be implemented by software in addition to a necessary universal hardware platform or by hardware only. Based on such an understanding, the technical solutions of this application essentially or the part contributing to the prior art may be implemented in a form of a software product. The computer software product is stored in a storage medium (such as a ROM/RAM, a magnetic disk, or an optical disc) and includes several instructions for instructing a terminal (which may be a mobile phone, a computer, a server, an air conditioner, or a network device) to execute the methods described in the embodiments of this application.

The embodiments of this application are described above in conjunction with the accompanying drawings, but this application is not limited to the above specific implementations, and the above specific implementations are only illustrative and not restrictive. Enlightened by this application, a person of ordinary skill in the art can make many forms without departing from the purpose of this application and the protection scope of the claims, all of which shall fall within the protection of this application.

1. An uplink data sending method, performed by a terminal, comprising:
when a plurality of transport blocks are transmittable on a same time-frequency resource of a same configured grant, selecting a first transport block from the plurality of transport blocks to transmit on the time-frequency resource, wherein the first transport block is a transport block to be retransmitted or a transport block with a highest logical channel priority among the plurality of transport blocks.

2. The uplink data sending method according to claim 1, wherein the first transport block is the transport block to be retransmitted among the plurality of transport blocks, and selecting the first transport block from the plurality of transport blocks to transmit on the time-frequency resource comprises:
when there are a plurality of transport blocks to be retransmitted among the plurality of transport blocks, selecting, from the plurality of transport blocks to be retransmitted, the transport block with the highest logical channel priority as the first transport block.

3. The uplink data sending method according to claim 2, wherein selecting, from the plurality of transport blocks to be retransmitted, the transport block with the highest logical channel priority as the first transport block comprises:
when the plurality of transport blocks to be retransmitted comprise a plurality of transport blocks to be retransmitted with equal and highest logical channel priorities, selecting, from the plurality of transport blocks to be retransmitted with equal and highest logical channel priorities, one transport block as the first transport block according to at least one of the following rules:
selecting, from the plurality of transport blocks to be retransmitted with equal and highest logical channel priorities, a transport block with a maximum number of retransmissions as the first transport block;
obtaining priorities corresponding to logical channels with second highest priorities among the plurality of transport blocks to be retransmitted with equal and highest logical channel priorities, selecting a first logical channel with a highest priority from the logical channels with the second highest priorities, and using a transport block to be retransmitted corresponding to the first logical channel as the first transport block;
selecting, from the plurality of transport blocks to be retransmitted with equal and highest logical channel priorities, a transport block with a largest or smallest hybrid automatic repeat request (HARQ) process identifier as the first transport block;
selecting, from the plurality of transport blocks to be retransmitted with equal and highest logical channel priorities, a transport block with a latest or earliest transmission failure as the first transport block; or
selecting, from the plurality of transport blocks to be retransmitted with equal and highest logical channel priorities, a transport block carrying a media access control control element (MAC CE) as the first transport block.

4. The uplink data sending method according to claim 1, wherein the first transport block is a transport block with the highest logical channel priority among the plurality of transport blocks, and selecting the first transport block from the plurality of transport blocks to transmit on the time-frequency resource comprises:
when there are a plurality of transport blocks with the highest logical channel priority among the plurality of transport blocks, selecting one transport block from the plurality of transport blocks with the highest logical channel priority as the first transport block according to at least one of the following rules:
obtaining priorities corresponding to logical channels with second highest priorities among the plurality of transport blocks with the highest logical channel priority, selecting a first logical channel with a highest priority from the logical channels with the second highest priorities, and using a transport block corresponding to the first logical channel as the first transport block;
selecting, from the plurality of transport blocks with the highest logical channel priority, a transport block to be retransmitted as the first transport block;
selecting, from the plurality of transport blocks with the highest logical channel priority, a transport block with a largest or smallest HARQ process identifier as the first transport block; or
selecting, from the plurality of transport blocks with the highest logical channel priority, a transport block carrying a MAC CE as the first transport block.

5. The uplink data sending method according to claim 4, wherein selecting, from the plurality of transport blocks with the highest logical channel priority, the transport block to be retransmitted as the first transport block comprises:
when there are a plurality of transport blocks to be retransmitted among the plurality of transport blocks with the highest logical channel priority, selecting one transport block from the plurality of transport blocks to be retransmitted as the first transport block according to at least one of the following rules:
obtaining priorities corresponding to logical channels with second highest priorities among the plurality of transport blocks to be retransmitted, selecting a first logical channel with a highest priority from the logical channels with the second highest priorities, and using a transport block to be retransmitted corresponding to the first logical channel as the first transport block;
selecting, from the plurality of transport blocks to be retransmitted, a transport block with a maximum number of retransmissions as the first transport block;
selecting, from the plurality of transport blocks to be retransmitted, a transport block with a largest or smallest HARQ process identifier as the first transport block;
selecting, from the plurality of transport blocks to be retransmitted, a transport block with a latest or earliest transmission failure as the first transport block; or
selecting, from the plurality of transport blocks to be retransmitted, a transport block carrying a MAC CE as the first transport block.

6. The method according to claim 3, wherein the rules are determined by the terminal, or configured by a network side, or specified by a protocol.

7. The uplink data sending method according to claim 1, wherein it is specified by a protocol that a transport block to be retransmitted or a transport block with the highest logical channel priority is selected from the plurality of transport blocks as the first transport block.

8. The uplink data sending method according to claim 1, further comprising:
receiving configuration information sent from a network side, wherein the configuration information is used to instruct the terminal to select, when a plurality of transport blocks are transmitted on a same time-frequency resource of a same configured grant, the transport block to be retransmitted or the transport block with the highest logical channel priority from the plurality of transport blocks as the first transport block for transmission.

9. The uplink data sending method according to claim 8, wherein the configuration information is carried by using radio resource control (RRC) signaling.

10. The uplink data sending method according to claim 8, wherein the configuration information is specific to each Configured Grant (CG), or specific to each MAC entity, or specific to each cell group, or specific to each cell.

11. The uplink data sending method according to claim 1, wherein the time-frequency resource is an unlicensed band resource.

12. An uplink data sending configuration method, performed by a network side device, comprising:
sending configuration information to a terminal, wherein the configuration information is used to instruct the terminal to select, when a plurality of transport blocks are transmittable on a same time-frequency resource of a same configured grant, the transport block to be retransmitted or the transport block with the highest logical channel priority from the plurality of transport blocks as the first transport block for transmission.

13. The uplink data sending configuration method according to claim 12, wherein the configuration information is carried by using RRC signaling.

14. The uplink data sending configuration method according to claim 12, wherein the configuration information is specific to each Configured Grant (CG), or specific to each MAC entity, or specific to each cell group, or specific to each cell.

15. A terminal, comprising:
a memory storing a computer program; and
a processor coupled to the memory and configured to execute the computer program to perform operations comprising:
when a plurality of transport blocks are transmittable on a same time-frequency resource of a same configured grant, selecting a first transport block from the plurality of transport blocks to transmit on the time-frequency resource, wherein the first transport block is a transport block to be retransmitted or a transport block with a highest logical channel priority among the plurality of transport blocks.

16. The terminal according to claim 15, wherein the first transport block is the transport block to be retransmitted among the plurality of transport blocks, and selecting the first transport block from the plurality of transport blocks to transmit on the time-frequency resource comprises:
when there are a plurality of transport blocks to be retransmitted among the plurality of transport blocks, selecting, from the plurality of transport blocks to be retransmitted, the transport block with the highest logical channel priority as the first transport block.

17. The terminal according to claim 16, wherein selecting, from the plurality of transport blocks to be retransmitted, the transport block with the highest logical channel priority as the first transport block comprises:
when the plurality of transport blocks to be retransmitted comprise a plurality of transport blocks to be retransmitted with equal and highest logical channel priorities, selecting, from the plurality of transport blocks to be retransmitted with equal and highest logical channel priorities, one transport block as the first transport block according to at least one of the following rules:
selecting, from the plurality of transport blocks to be retransmitted with equal and highest logical channel priorities, a transport block with a maximum number of retransmissions as the first transport block;
obtaining priorities corresponding to logical channels with second highest priorities among the plurality of transport blocks to be retransmitted with equal and highest logical channel priorities, selecting a first logical channel with a highest priority from the logical channels with the second highest priorities, and using a transport block to be retransmitted corresponding to the first logical channel as the first transport block;
selecting, from the plurality of transport blocks to be retransmitted with equal and highest logical channel priorities, a transport block with a largest or smallest hybrid automatic repeat request (HARD) process identifier as the first transport block;
selecting, from the plurality of transport blocks to be retransmitted with equal and highest logical channel priorities, a transport block with a latest or earliest transmission failure as the first transport block; or
selecting, from the plurality of transport blocks to be retransmitted with equal and highest logical channel priorities, a transport block carrying a media access control control element (MAC CE) as the first transport block.

18. The terminal according to claim 15, wherein the operations further comprise:
receiving configuration information sent from a network side, wherein the configuration information is used to instruct the terminal to select, when a plurality of transport blocks are transmitted on a same time-frequency resource of a same configured grant, the transport block to be retransmitted or the transport block with the highest logical channel priority from the plurality of transport blocks as the first transport block for transmission.

19. The terminal according to claim 18, wherein the configuration information is specific to each Configured Grant (CG), or specific to each MAC entity, or specific to each cell group, or specific to each cell.

20. The terminal according to claim 15, wherein the time-frequency resource is an unlicensed band resource.
